(19) United States
(12) Patent Application Publication
(10) Pub. No.: US 2026/0073817 A1
(43) Pub. Date: Mar. 12, 2026

(54) DISPLAY SYSTEM

(71) Applicant: LightnTec GmbH, Karlsruhe (DE)

(72) Inventor: Florian Kall, Karlsruhe (DE)

(73) Assignee: LightnTec GmbH, Karlsruhe (DE)

(21) Appl. No.: 19/317,142

(22) Filed: Sep. 3, 2025

(30) Foreign Application Priority Data
Sep. 9, 2024 (DE) 102024125800.4

(51) Int. Cl. G09F 9/30; G09F 9/33

(52) U.S. Cl. CPC G09F 9/301; G09F 9/33

(57) ABSTRACT

An advertising installation has a flexible LED film that is fastened in a holder. The holder exerts a tensile force on the LED film. The LED film is stretched with a tensile stress. The LED film comprises LEDs that can be controlled independently of one another. Preferably, the LED film can be rolled up, wherein the rolled-up LED film has the shape of a hollow cylinder with an inner diameter of less than 100 mm and more than 10 mm.

### CROSS-REFERENCE TO RELATED APPLICATIONS

This application claims priority to German Patent Application No. DE 10 2024 125 800.4, filed Sep. 9, 2024, the entire contents of which are hereby incorporated in full by this reference.

### DESCRIPTION

### Field of the Invention

The invention relates to an advertising (a display) installation having the following features:
a) a flexible LED film which can be, in particular, rolled up to a diameter of less than 100 mm and which comprises a plurality of individually controllable LEDs;
b) a holder for fastening the LED film.

The invention further relates to a method for producing an advertising installation.

### BACKGROUND OF THE INVENTION

In well-known advertising installations, the shape of the LED films can change relatively easily.

### SUMMARY OF THE INVENTION

### Object of the Invention

It is the object of the invention to provide an advertising installation in which the LED film is held in a dimensionally stable manner in the holder. It is a further object of the invention to present a method for producing an advertising installation.

### Description of the Invention

This object is achieved according to the invention by an advertising installation according to claim 1 and by a method according to claim 6. Advantageous embodiments are apparent from the dependent subclaims.

The advertising installation according to the invention is characterized in that the LED film is stretched into the holder.

The tensile forces occurring in the LED film advantageously counteract a change in the shape of the LED film in the holder. The tensile forces are, in particular, 1 kN to 10 kN, preferably 3 kN to 5 kN.

The holder is preferably designed in the form of a frame. The holder can be polygonal, in particular, rectangular.

In a preferred embodiment of the advertising installation, a keder bead of the advertising installation is arranged on or formed on the LED film, which is inserted into a keder rail of the holder. A keder connection is characterized by high tensile load capacity and ease of handling.

An embodiment is advantageous in which the holder comprises a hollow retaining element that is fastened to the LED film, wherein a rail of the holder is guided through the retaining element. The rail is preferably part of a tubular frame of the holder. The rail can be easily guided through the retaining element, as a result of which easy installation is made possible.

An advantageous embodiment is one in which the LED film comprises ring eyelets that are fastened to the holder of the advertising installation with springs and/or rubber bands. As a result, the holder can be designed with very little material.

Furthermore, an embodiment is preferred in which a deep black layer of the advertising installation is provided around the LEDs. As a result, the light emitted by the LEDs is particularly well visible.

The LED film can comprise a flexible base body on which the LEDs are arranged, wherein, in particular, a controller for individually controlling a plurality of LEDs is also arranged on the base body.

The LEDs can be arranged in a matrix and, in particular, in each case have a spacing from the next adjacent LED of 1 mm to 80 mm.

The LEDs preferably have a spacing to the next adjacent LED (“pixel pitch”) of more than 2 mm, in particular, more than 5 mm.

The LEDs can be designed in the form of LED modules with a plurality of color diodes, for example in the form of RGB LEDs.

The invention further relates to an advertising installation having the following features:
A) a flexible LED film, which can be, in particular, rolled up to a diameter of less than 100 mm, and which comprises a plurality of individually controllable LEDs;
B) a housing for fastening the LED film; wherein
C) the housing comprises a pane, in particular, a transparent pane, for the direct or indirect fastening of the LED film.

Such an advertising installation constitutes an independent aspect of the invention. The advertising installation can comprise one, a plurality of or all of the features mentioned above.

The LED film can be formed substantially parallel to the pane. The pane can be designed so as to be at least sectionally bent. The pane can be designed in the form of a plastic pane. The pane is preferably made of acrylic glass, polycarbonate, PVC and/or PETG. The pane can be in the form of an aluminum composite panel (“Alucobond®”). The aluminum composite panel preferably comprises a plastic pane coated on both sides.

The LED film can be arranged directly on the pane.

The pane can comprise recesses in each of which at least one LED of the LED film is arranged.

If a deep black layer of the advertising installation is provided around the LEDs, the pane can be arranged between the LED film and the deep black layer.

The pane can be designed in the form of a dome.

The housing can be designed in the form of a poster advertising box, a fascia façade strip or a high-rise sign. Poster advertising boxes are also known as poster stands. Fascia façade strips are typically used on the front sides of gas station canopies. High-rise signs have advertising space on a very high post so that they are visible from a distance, for example from a highway.

A method for producing an advertising installation comprises the following steps:
A) removal of a poster or tarpaulin in an advertising installation;
B) replacing the poster or the tarpaulin with the LED film, wherein an advertising installation according to one of the preceding claims is obtained.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1a is a schematic three-dimensional representation of an advertising installation in a construction phase;

FIG. 1b is a three-dimensional representation of the advertising installation from FIG. 1a in the completed state;

FIG. 1c is a detail of the advertising installation from FIG. 1b, namely a three-dimensional representation of an LED film with keder beads arranged on its edge;

FIG. 1d is a three-dimensional representation of an embodiment of an advertising installation having a keder rail for receiving the keder beads from FIG. 1c;

FIG. 2a is an embodiment of an advertising installation having an LED film on a support frame;

FIG. 2b is a detailed view of the advertising installation according to FIG. 2a;

FIG. 3a shows a further embodiment of an advertising installation having an LED film and a holder in the form of a frame structure;

FIG. 4a shows an embodiment of an advertising installation having a housing and a pane;

FIG. 4b is a longitudinal section through the advertising installation according to FIG. 4a;

FIG. 4c is a longitudinal section through a further embodiment of an advertising installation having a housing and a pane;

FIG. 5a is an embodiment of an advertising installation having a poster advertising box;

FIG. 5b is an exploded view of the advertising installation according to FIG. 5a;

FIG. 6a is an embodiment of an advertising installation having an façade strip; and

FIG. 7a is an embodiment of an advertising installation having a high-rise sign.

### DETAILED DESCRIPTION OF EMBODIMENTS OF THE INVENTION

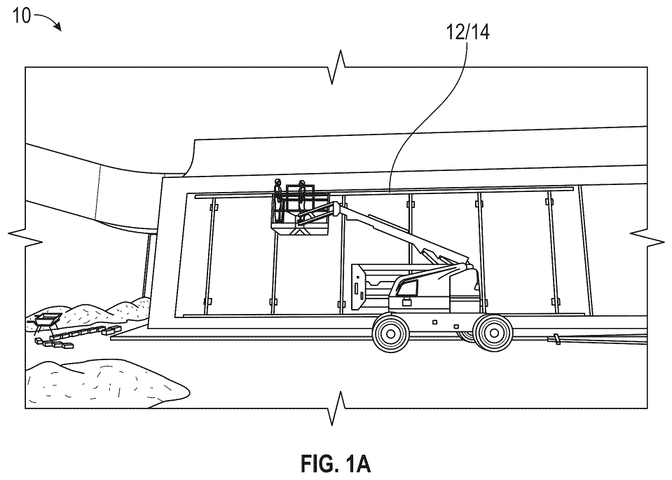

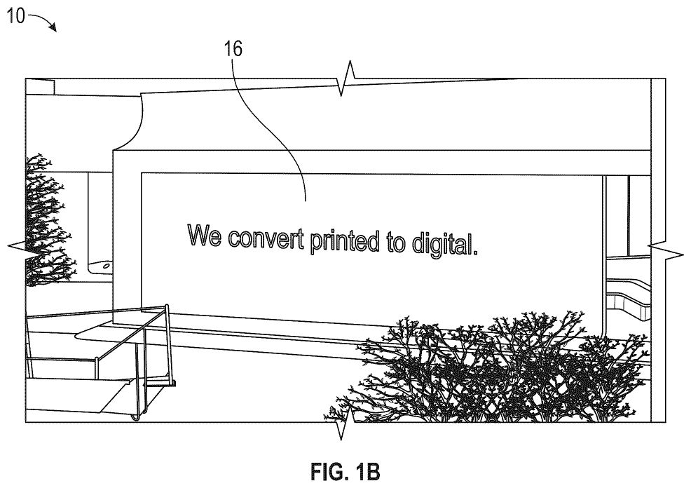

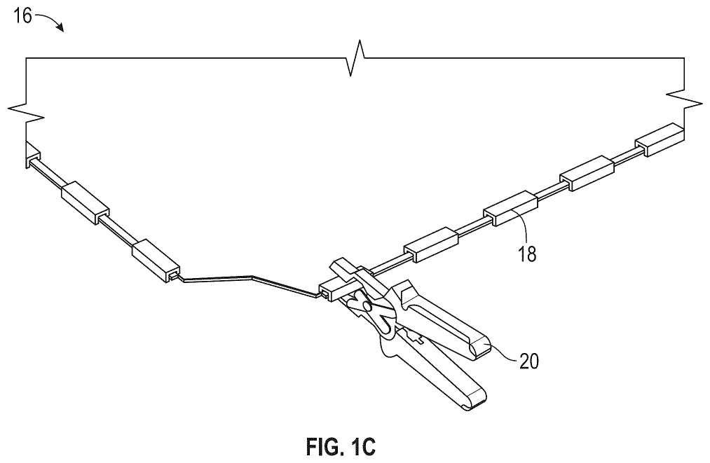

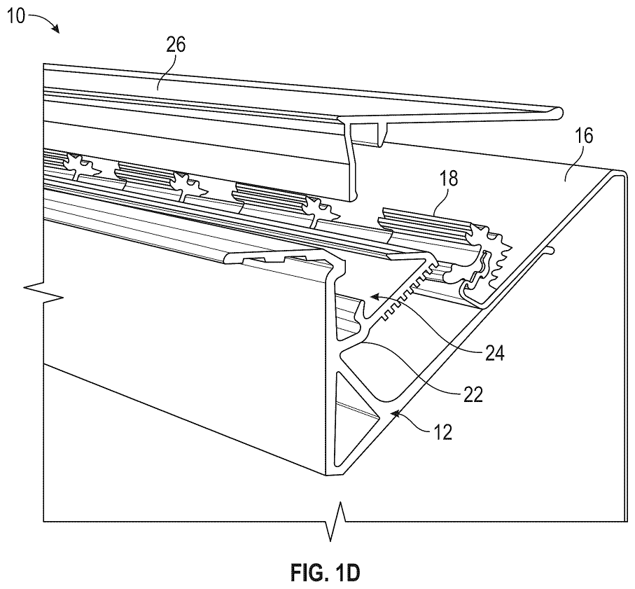

FIG. 1a is a schematic three-dimensional representation of an advertising installation 10 in a construction phase. Shown, in particular, is a holder 12 for an LED film 16 (see FIG. 1b) in the form of a frame 14 into which the LED film 16 is clamped.

FIG. 1b is a three-dimensional representation of the advertising installation 10 from FIG. 1a in its completed state. The LED film 16 is clamped into the frame 14 (see FIG. 1a).

FIG. 1c is a detail of the advertising installation 10 from FIG. 1b, namely a three-dimensional representation of the LED film 16 with keder beads 18 arranged on its edge. With the aid of pliers 20, the keder beads 18 are fastened to the edge of the film 16.

FIG. 1d is a three-dimensional representation of an embodiment of an advertising installation 10 for receiving the keder beads 18 from FIG. 1c. The advertising installation 10 is formed with the LED film 16 and the holder 12, which comprises a keder rail 22. Keder beads 18 are fastened to the LED film 16, in particular, to the edge of the LED film 16, which can be inserted into a groove 24 of the keder rail 22 in order to mount the LED film 16 on the keder rail 22. Subsequently, the groove 24 can be covered with a cover 26 in order to protect the groove 24 with the keder beads 18 located in the groove 24.

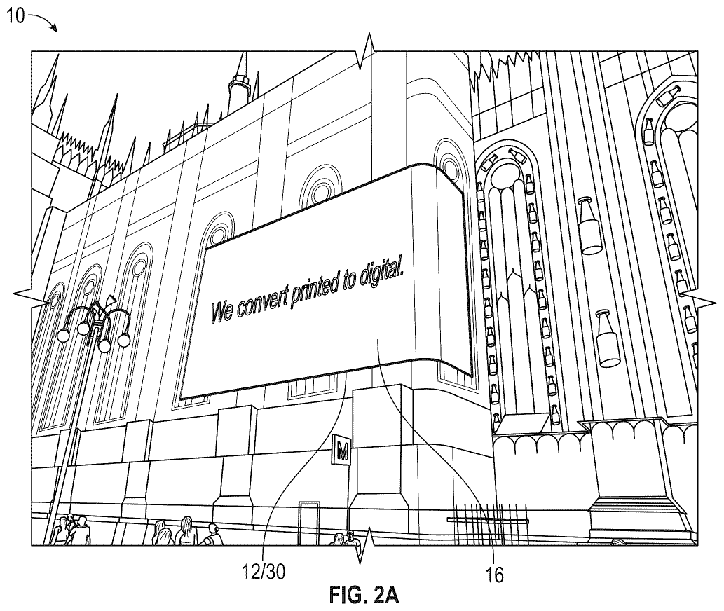

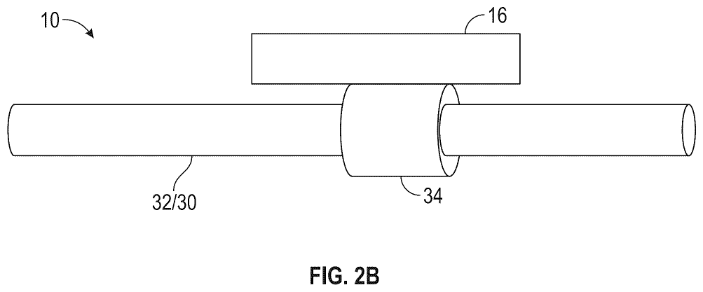

FIG. 2a shows a further embodiment of an advertising installation 10 having an LED film 16 on a holder 12 in the form of a support frame 30. The LED film 16 is fastened to the support frame 30, in particular, clamped into the support frame 30.

FIG. 2b is a detailed view of the advertising installation 10 according to FIG. 2a. Shown is a rail 32 of the support frame 30, which passes through a retaining element 34 of the LED film 16. The retaining element 34 is designed as a tube, in particular, as a hollow cylinder, and is firmly connected to the LED film 16. The advertising installation 10 comprises further, identically designed retaining elements 34 (not shown) through which the rails 32 of the support frame 30 pass. As a result, the LED film 16 can be stretched securely onto the support frame 30.

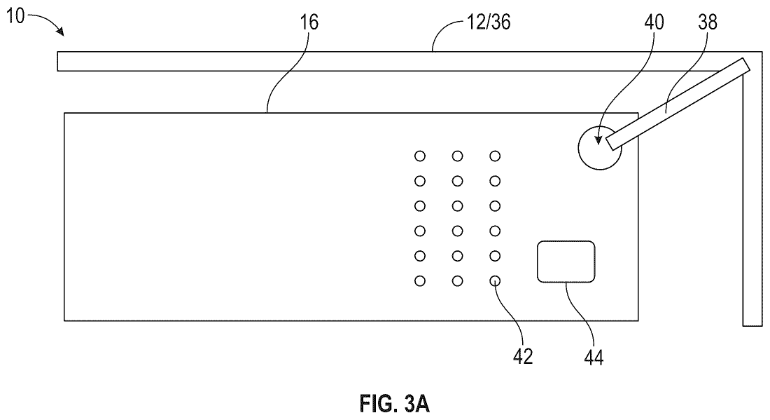

FIG. 3a shows a further embodiment of an advertising installation 10 having an LED film 16 and a holder 12 in the form of a frame structure 36. Shown is a retaining strap 38 fastened to the frame structure 36, which is passed through a ring eyelet 40 of the LED film 16 in order to stretch the LED film 16 onto the frame structure 36 in this way. The retaining strap 38 is designed, in particular, as a spring and/or rubber band. By means of the retaining strap 38 and the ring eyelet 40, along with further corresponding retaining straps 38 and ring eyelets 40 (not shown), the LED film 16 is securely held on the frame structure 36. Also shown are LEDs 42 of the LED film 16, along with a control unit 44 of the LED film 16 for controlling the LEDs 42.

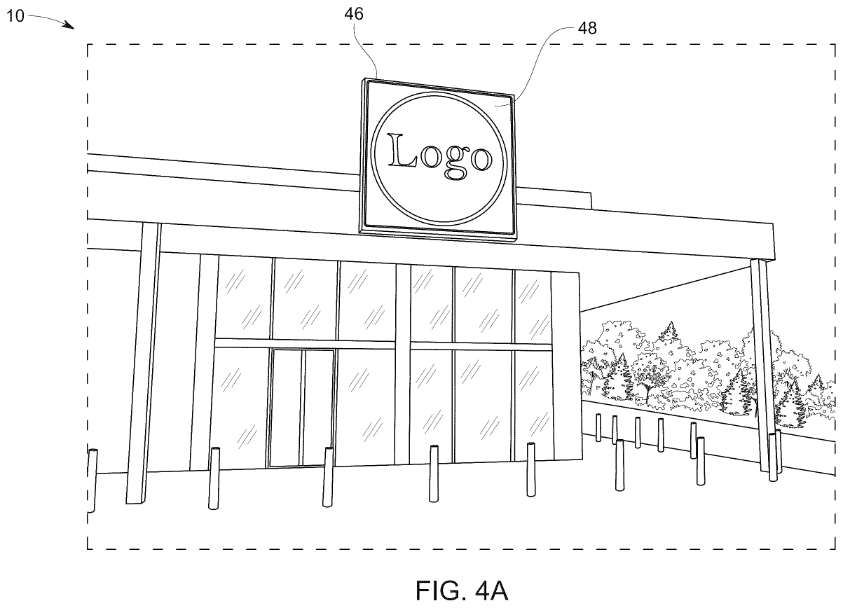

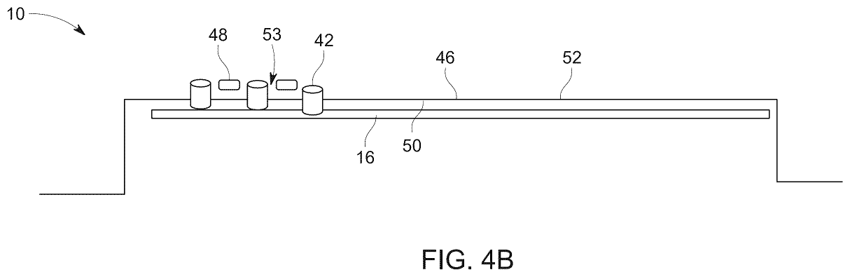

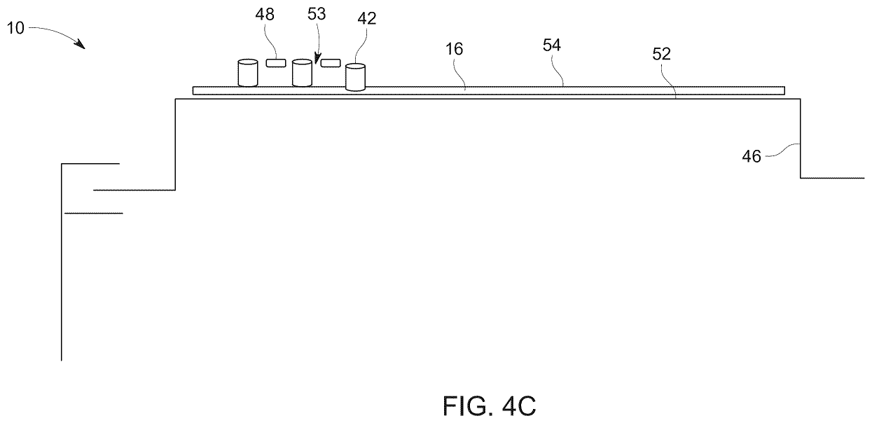

FIG. 4a shows a further embodiment of an advertising installation 10. Shown, in particular, are a housing 46 of the advertising installation 10 and a layer 48 of the advertising installation 10, which surround the LED film 16 (see FIG. 4b) of the advertising installation 10. The layer 48, in particular, comprises deep black material, such as Vantablack, in order to increase contrast in daylight.

FIG. 4b schematically shows a longitudinal section through a further embodiment of an advertising installation 10. The LED film 16 is arranged on an inner side 50 of the housing 46, while the layer 48 is positioned on an outer side 52 of the housing 46. LEDs 42 of the LED film 16 extend through recesses 53 in the housing 46 and the layer 48. The housing 46 and the layer 48 protect the LED film 16 particularly well.

FIG. 4c schematically shows a longitudinal section through a further embodiment of an advertising installation 10 with the housing 46 and the layer 48. The LED film 16 is arranged on the outer side 52 of the housing 46, wherein the layer 48 is positioned on an outer side 54 (the side facing away from the housing 46) of the LED film 16. The LEDs 42 of the LED film 16 protrude through the recesses 53 of the layer 48. In this embodiment, the recesses 53 only need to be formed in the layer 48.

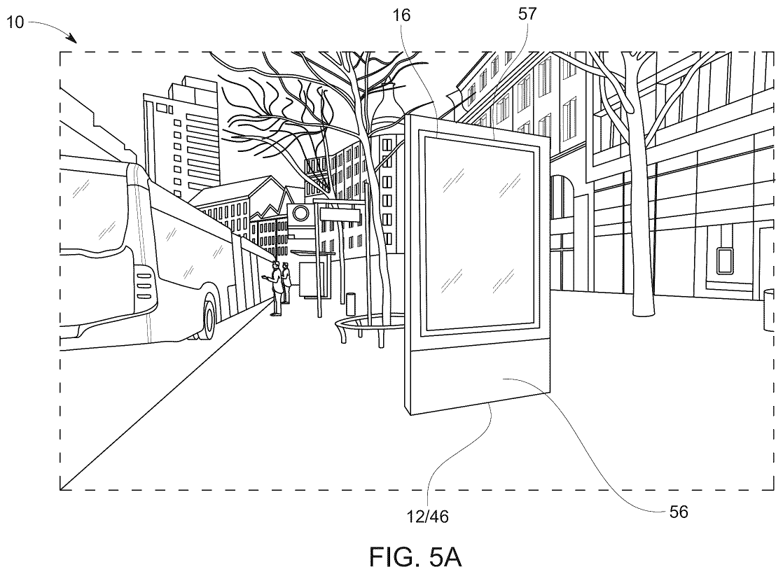

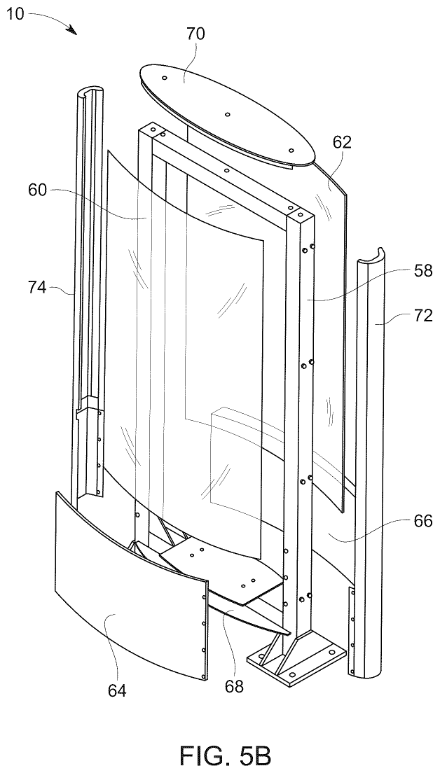

FIG. 5a shows a further embodiment of an advertising installation 10 having a holder 12 in the form of a housing 46 designed as a poster advertising box, which comprises a base 56. The LED film 16 is fastened behind a transparent pane 57 above the base 56 in the holder 12.

The embodiments of an advertising installation 10 shown in FIG. 5a-7a represent an independent aspect of the invention. The embodiments of an advertising installation 10 shown in these figures can comprise individual, a plurality of or all features of the particular advertising installation 10 shown in FIG. 1a-4c.

The LED film 16 can be formed substantially parallel to the pane 57. The pane 57 can be designed to be at least sectionally curved. The pane 57 can be designed in the form of a plastic pane. The pane 57 is preferably made of acrylic glass, polycarbonate, PVC and/or PETG. The pane 57 can be in the form of an aluminum composite panel (“Alucobond®”). The aluminum composite panel is preferably a plastic pane coated on both sides.

FIG. 5b is an exploded view of the advertising installation 10 according to FIG. 5a. Transparent panes 60, 62 of the advertising installation 10 are mounted on a support frame 58 of the advertising installation 10 and protect an LED film 16 (see FIG. 5a) of the advertising installation 10 from the front and from behind. Protective panels 64, 66 along with a base and a cover panel 68, 70 close off the advertising installation 10 at the top and bottom. Protective rails 72, 74 ensure protection of the support frame 58 in the lateral direction of the advertising installation 10. The elements of the advertising installation 10 mentioned in FIG. 5b form, in particular, a poster advertising box.

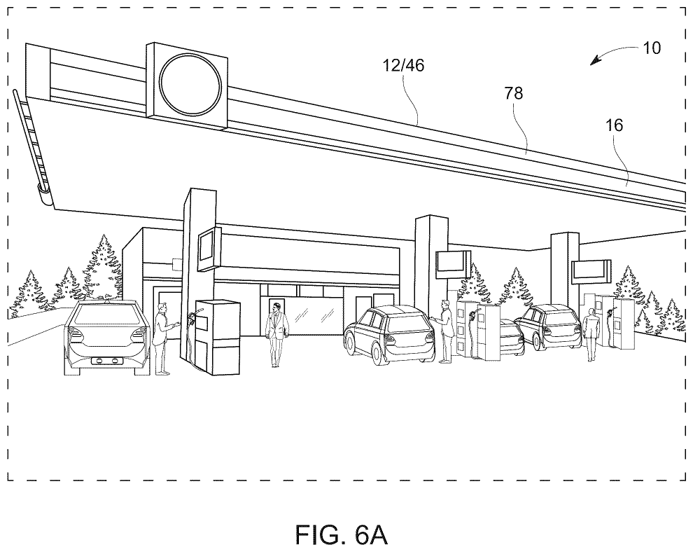

FIG. 6a illustrates a further embodiment of an advertising installation 10 having a holder 12 in the form of an elongated housing 46, here, in particular, in the form of a fascia façade strip, on the outer side of which 78 the LED film 16 is fastened, in particular, glued. Alternatively, the LED film is fastened to the inner side (not shown) of the housing 46.

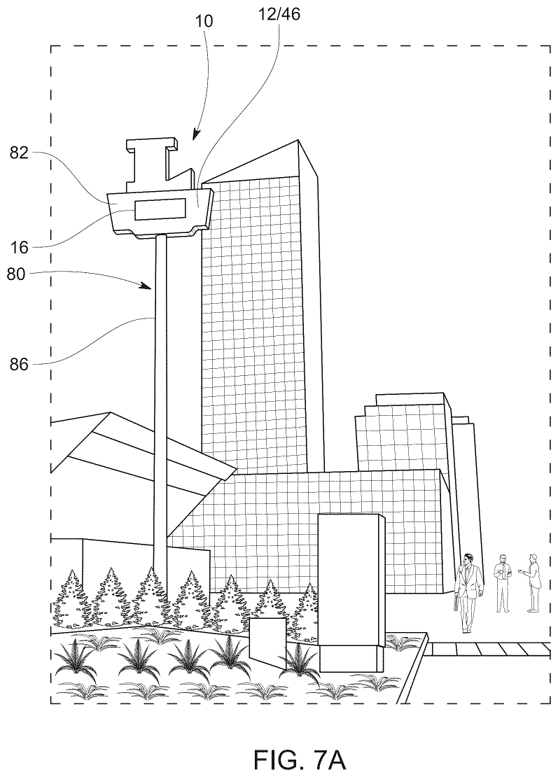

FIG. 7a illustrates a further embodiment of an advertising installation 10 having a holder 12 which comprises a housing 46 of a high-rise sign 80. The LED film 16 of the advertising installation 10 is mounted on an outer side 82 of the housing 46, in particular, glued, or fastened to the inner side (not shown) of the housing 46. The housing 46 is mounted on a post 86 at a relatively high height, typically at least 10 m.

Taking into account all the figures in the drawing, the invention relates, in particular, to an advertising installation 10 having a flexible LED film 16 that is fastened in a holder 12, wherein the holder 12 exerts a tensile force on the LED film 16. The LED film is stretched with a tensile stress. The LED film 16 comprises LEDs 42 that can be controlled independently of one another. Preferably, the LED film 16 can be rolled up, wherein the rolled-up LED film 16 has the shape of a hollow cylinder with an inner diameter of less than 100 mm and more than 10 mm.

### LIST OF REFERENCE SIGNS

10 Advertising installation
12 Holder
14 Frame
16 LED film
18 Keder bead
20 Pliers
22 Keder rail
24 Groove
26 Cover
30 Support frame
32 Rail
34 Retaining element
36 Frame structure
38 Retaining strap
40 Ring eyelet
42 LED module
44 Control unit
46 Housing
48 Deep black layer
50 Inner side
52 Outer side
54 Openings
56 Holder
57 Pane
58 Support frame
60 Pane
62 Pane
64 Protective panel
66 Protective panel
68 Base panel
70 Cover panel
72 Protective rail
74 Protective rail
78 Outer side
80 High-rise sign
82 Outer side
86 Post

What is claimed is:

1. An advertising installation, comprising:
a) a flexible LED film configured to be rolled up to a diameter of less than 100 mm, and which comprises a plurality of individually controllable LEDs;
b) a holder for fastening the LED film; and
c) wherein the LED film is stretched into the holder.

2. The advertising installation according to claim 1, wherein a keder bead of the advertising installation is arranged or formed on the LED film and is inserted into a keder rail of the holder.

3. The advertising installation according to claim 1, wherein the holder comprises a hollow retaining element that is fastened to the LED film, wherein a rail of the holder is guided through the retaining element.

4. The advertising installation according to claim 1, wherein the LED film comprises ring eyelets that are fastened to the holder of the advertising installation with springs and/or rubber bands.

5. The advertising installation according to claim 1, wherein a deep black layer of the advertising installation is provided around the LEDs.

6. A method for producing the advertising installation according to claim 1, comprising the method steps of:
A) removing a poster or tarpaulin in the advertising installation; and
B) replacing the poster or tarpaulin with the LED film.
